(19) United States
(12) Patent Application Publication
(10) Pub. No.: US 2025/0111525 A1
(43) Pub. Date: Apr. 3, 2025

(54) MULTI-CAMERA ALIGNMENT USING REGION OF INTEREST (ROI) REFINEMENT

(71) Applicant: QUALCOMM Incorporated, San Diego, CA (US)

(72) Inventors: Wen-Chun Feng, New Taipei City (TW); Jie Song, Shanghai (CN); Yu-Ren Lai, Xinyi District (TW); Shizhong Liu, San Diego, CA (US); Weiliang Liu, San Diego, CA (US)

(21) Appl. No.: 18/729,081

(22) PCT Filed: Mar. 25, 2022
(86) PCT No.: PCT/CN2022/083060

§ 371 Date: Jul. 15, 2024

(51) Int. Cl. G06T 7/30; G06T 7/194; G06T 7/215; G06T 7/50

(52) U.S. Cl. CPC G06T 7/30; G06T 7/194; G06T 7/215; G06T 7/50

(57) ABSTRACT

This disclosure provides systems, methods, and devices for image processing. In a first aspect, a method of image processing includes receiving first image data from a first camera of an image capture device, wherein the first camera is different from a second camera of the image capture device; determining a first portion of the first image data; transforming the first portion of the first image data with a first strength based on an alignment difference between the first camera and the second camera; transforming a second portion of the first image data with a second strength based on the alignment difference between the first camera and the second camera; and determining a first output image frame based on the first image data after transforming the first portion of the first image data and transforming the second portion of the first image data. Other aspects and features are also described.

### TECHNICAL FIELD

Aspects of the present disclosure relate generally to image processing, and more particularly, to multiple camera operation. Some features may enable and provide improved image processing, including improved transitions when switching cameras.

### INTRODUCTION

Image capture devices are devices that can capture one or more digital images, whether still image for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computer devices such as webcams, video surveillance cameras, or other devices with digital imaging or video capabilities.

Image capture devices may include multiple camera modules. The camera modules may be arranged adjacent to each other causing the different camera modules to have different optical axes, and thus different fields of view. The different optical axes can cause abrupt shifts in the image data when switching from one camera module to another camera module.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

During an image capture operation, an image capture device may switch between available camera modules to obtain better image quality. Different camera modules may have different fields of view based on image sensor location (e.g., optical axes) and/or image sensor size. Spatial alignment transforms can be used to mask changes between camera modules having different optical axes. In some embodiments, different weights of spatial transform can be applied to different portions of image data based on the depth of objects in the different portions. Applying different weights of transform to portions of different depths reduces image distortion caused by the transform. For example, image data may be processed by determining a region of interest (ROI), which is refined from a local motion determination based on motion and depth. A morphological erosion and dilation may be applied on a motion vector map and the processed motion vector map may be input to a foreground finding algorithm, which applies connected component analysis and shift values to determine foreground portions. Depth may also be used to weight the confidence of the portion determination, and the local motion compensation may be constrained to the portions having a confidence above a threshold.

In one aspect of the disclosure, a method for image processing includes receiving first image data from a first camera of an image capture device, wherein the first camera is different from a second camera of the image capture device; determining a first portion of the first image data; transforming the first portion of the first image data with a first strength based on an alignment difference between the first camera and the second camera; transforming a second portion of the first image data with a second strength based on the alignment difference between the first camera and the second camera; and determining a first output image frame based on the first image data after transforming the first portion of the first image data and transforming the second portion of the first image data.

In an additional aspect of the disclosure, an apparatus includes at least one processor and a memory coupled to the at least one processor. The at least one processor is configured to perform operations including receiving first image data from a first camera of an image capture device, wherein the first camera is different from a second camera of the image capture device; determining a first portion of the first image data; transforming the first portion of the first image data with a first strength based on an alignment difference between the first camera and the second camera; transforming a second portion of the first image data with a second strength based on the alignment difference between the first camera and the second camera; and determining a first output image frame based on the first image data after transforming the first portion of the first image data and transforming the second portion of the first image data.

In an additional aspect of the disclosure, an apparatus includes means for receiving first image data from a first camera of an image capture device, wherein the first camera is different from a second camera of the image capture device; means for determining a first portion of the first image data; means for transforming the first portion of the first image data with a first strength based on an alignment difference between the first camera and the second camera; means for transforming a second portion of the first image data with a second strength based on the alignment difference between the first camera and the second camera; and means for determining a first output image frame based on the first image data after transforming the first portion of the first image data and transforming the second portion of the first image data.

In an additional aspect of the disclosure, a non-transitory computer-readable medium stores instructions that, when executed by a processor, cause the processor to perform operations. The operations include receiving first image data from a first camera of an image capture device, wherein the first camera is different from a second camera of the image capture device; determining a first portion of the first image data; transforming the first portion of the first image data with a first strength based on an alignment difference between the first camera and the second camera; transforming a second portion of the first image data with a second strength based on the alignment difference between the first camera and the second camera; and determining a first output image frame based on the first image data after transforming the first portion of the first image data and transforming the second portion of the first image data.

Image capture devices, devices that can capture one or more digital images whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computer devices such as webcams, video surveillance cameras, or other devices with digital imaging or video capabilities.

In general, this disclosure describes image processing techniques involving digital cameras having image sensors and image signal processors (ISPs). The ISP may be configured to control the capture of image frames from one or more image sensors and process one or more image frames from the one or more image sensors to generate a view of a scene in a corrected image frame. A corrected image frame may be part of a sequence of image frames forming a video sequence. The video sequence may include other image frames received from the image sensor or other images sensors and/or other corrected image frames based on input from the image sensor or another image sensor. In some embodiments, the processing of one or more image frames may be performed within the image sensor, such as in a binning module. The image processing techniques described in embodiments disclosed herein may be performed by circuitry, such as a binning module, in the image sensor, in the image signal processor (ISP), in the application processor (AP), or a combination or two or all of these components.

In an example, the image signal processor may receive an instruction to capture a sequence of image frames in response to the loading of software, such as a camera application, to produce a preview display from the image capture device. The image signal processor may be configured to produce a single flow of output frames, based on images frames received from one or more image sensors. The single flow of output frames may include raw image data from an image sensor, binned image data from an image sensor, or corrected image frames processed by one or more algorithms, such as in a binning module, within the image signal processor. For example, an image frame obtained from an image sensor, which may have performed some processing on the data before output to the image signal processor may be processed in the image signal processor by processing the image frame through an image post-processing engine (IPE) and/or other image processing circuitry for performing one or more of tone mapping, portrait lighting, contrast enhancement, gamma correction, etc.

After an output frame representing the scene is determined by the image signal processor using the image correction, such as binning described in various embodiments herein, the output frame may be displayed on a device display as a single still image and/or as part of a video sequence, saved to a storage device as a picture or a video sequence, transmitted over a network, and/or printed to an output medium. For example, the image signal processor may be configured to obtain input frames of image data (e.g., pixel values) from the different image sensors, and in turn, produce corresponding output frames of image data (e.g., preview display frames, still-image captures, frames for video, frames for object tracking, etc.). In other examples, the image signal processor may output frames of the image data to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. That is, the image signal processor may obtain incoming frames from one or more image sensors, each coupled to one or more camera lenses, and, in turn, may produce and output a flow of output frames to various output destinations.

In some aspects, the corrected image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The apparatus may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur with a lens cluster on a mobile device, such as where multiple image sensors and associated lenses are located in offset locations on a frontside or a backside of the mobile device. Additional image sensors may be included with larger, smaller, or same field of views. The image correction techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in as a recording or as streaming data, over a first network connection of a plurality of network connections; and a processor coupled to the first network adaptor, and the memory. The processor may cause the transmission of corrected image frames described herein over a wireless communications network such as a 5G NR communication network.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors according to one or more aspects of the disclosure.

FIG. 2 shows a block diagram illustrating an example method for processing image data according to some embodiments of the disclosure.

FIG. 3 shows a block diagram illustrating an example processor for processing image data for aligning image data when switching between cameras according to some embodiments of the disclosure.

FIG. 4 shows a flow chart illustrating an example method for processing image data according to some embodiments of the disclosure.

FIG. 5 shows a block diagram illustrating an example method for processing image data with region of interest (ROI) identification according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

During an image capture operation, an image capture device may switch between available camera modules to obtain better image quality. Different camera modules may have different fields of view based on image sensor location (e.g., optical axes) and/or image sensor size. Spatial alignment transforms can be used to mask changes between camera modules having different optical axes. However, global alignment transforms can cause visible shifts when changing camera modules in scenes with objects at multiple depths due to different disparities at the different depth values. For example, applying a global transform may result in a foreground object appearing to move slightly upon camera transition.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

The present disclosure provides systems, apparatus, methods, and computer-readable media that support improved image alignment during camera module changes for compensating for change in a representation of the scene as a result of changing camera modules. In some embodiments, the region of interest (ROI) may be refined for local motion determination based on motion, depth, focus, saliency, and/or other information. A morphological erosion and dilation may be applied on a motion vector map and the processed motion vector map may be input to a foreground finding algorithm, which applies connected component analysis and shift values to determine foreground portions. Depth may also be used to weight the confidence of the portion determination, and the local motion compensation may be constrained to the portions having a confidence above a threshold.

Particular implementations of the subject matter described in this disclosure may be implemented to realize one or more of the following potential advantages or benefits. In some aspects, the present disclosure provides techniques for improving image appearance by reducing unusual or unexpected image shifts as seen by a user when displaying, recording, and/or transmitting image data received while switching camera modules. Compensating for the changing optical axes of the different camera modules may provide more realistic appearing images with objects at multiple depths by compensating for different depths within the scene. Additionally, generation of a preview during a change in camera modules using aspects of this disclosure may display smoother transitions in the display window.

An example device for capturing image frames using one or more image sensors, such as a smartphone, may include a configuration of two, three, four, or more cameras on a backside (e.g., a side opposite a user display) or a front side (e.g., a same side as a user display) of the device. Devices with multiple image sensors include one or more image signal processors (TSPs), Computer Vision Processors (CVPs) (e.g., AT engines), or other suitable circuitry for processing images captured by the image sensors. The one or more image signal processors may provide processed image frames to a memory and/or a processor (such as an application processor, an image front end (IFE), an image processing engine (IPE), or other suitable processing circuitry) for further processing, such as for encoding, storage, transmission, or other manipulation.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including or coupled to two or more image sensors capable of capturing image frames (or “frames”). Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

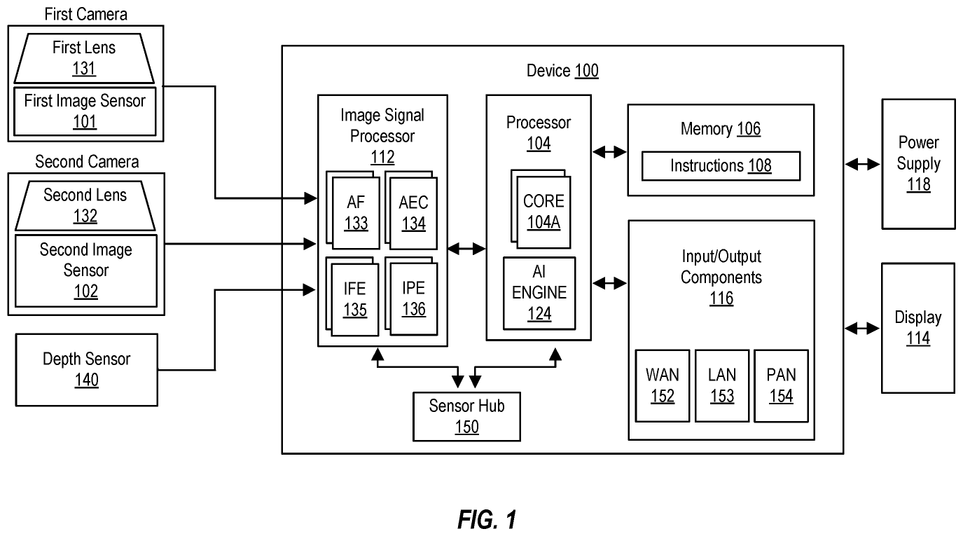

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons. I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands. The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In some aspects, a gyroscope in an electronic image stabilization system (EIS) may be coupled to the sensor hub or coupled directly to the image signal processor 112. In another example, a non-camera sensor may be a global positioning system (GPS) receiver.

The image signal processor 112 may receive image data, such as used to form image frames. In one embodiment, a local bus connection couples the image signal processor 112 to image sensors 101 and 102 of a first and second camera, respectively. In another embodiment, a wire interface couples the image signal processor 112 to an external image sensor. In a further embodiment, a wireless interface couples the image signal processor 112 to the image sensor 101, 102.

The first camera may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors. That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112 and output from the depth sensors processed in a similar manner to that of image sensors 101 and 102. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), and/or one or more auto exposure compensation (AEC) 134 engines. The AF 133, AEC 134, AFE 135, APE 136 may each include application-specific circuitry, be embodied as software code executed by the ISP 112, and/or a combination of hardware within and software code executing on the ISP 112. The ISP 112 may additionally execute an automatic white balancing (AWB) engine for performing white balancing operations. The AWB engine may execute in, for example, the image front ends (IFEs) 135 or other dedicated or general processing circuitry within the ISP 112 or the image capture device 100, such as on a digital signal processor (DSP).

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system on chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including noise reduction operations. For example, execution of the instructions can instruct the image signal processor 112 to begin or end capturing an image frame or a sequence of image frames, in which the capture includes noise reduction as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, the camera application may receive a command to begin a video preview display upon which a video comprising a sequence of image frames is captured and processed from one or more image sensors 101 or 102. Image correction, such as with cascaded IPEs, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124) in addition to the ability to execute software to cause the device 100 to perform a number of functions or operations, such as the operations described herein. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

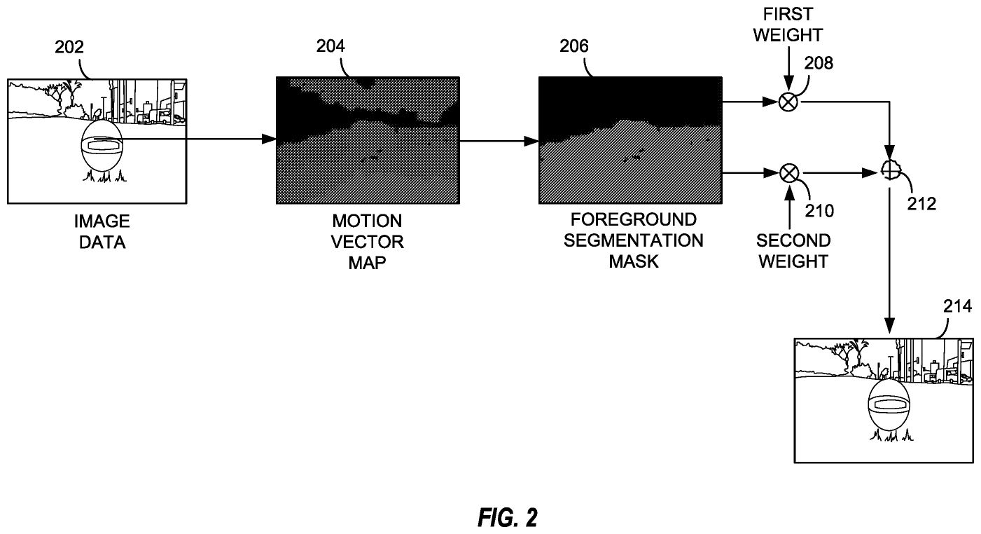

In some embodiments of an image capture device, the device may support switching between a first camera and a second camera (or additional cameras, such as third and fourth cameras). The device may perform operations described with reference to FIGS. 2-5 to process image data when switching between the first camera and the second camera. In some embodiments, the image processing described herein may be performed separate from the capture of the image data, such as when aspects of the image processing described herein are performed after acquiring and storing the image data.

FIG. 2 shows a block diagram illustrating an example method for processing image data according to some embodiments of the disclosure. Image data 202 may be received from a camera module, memory, cloud storage, or other source. The image data 202 may be processed to determine a motion vector map 204. The map 204 may be an array of motion vectors representing motion in the scene represented by the image data. The motion vector map 204 may be used to segment a foreground portion from a background portion represented by a segmentation mask 206. The mask 206 may be a set of values with a first value, such as ‘0’ shown as white in the image, indicating the corresponding portion of the scene is a foreground portion, or with a second value, such as ‘1’ shown as black in the image, indicating the corresponding portion of the scene is a background portion. In some embodiments, the mask 206 may be non-binary, such as when multiple depths are represented in the mask 206. For example, there may be an object at a first depth, such as a person in a portrait, an object at a second depth, such as a person walking in the distance, and an object at a third depth, such as a tree further away than the person walking. The mask 206 may have three values, e.g., 0, 1, or 2, corresponding to these three depths. In some embodiments, the mask 206 includes real values between a minimum and maximum value indicate a variety of depths in the image. Although the mask 206 is described as determined from the motion vector map 204, the mask 206 may be determined from other data or in combination with other data, such as a focus map, depth map, user input, and/or object recognition (e.g., face recognition).

During operation of an image capture device with multiple camera modules, the device may switch between the camera modules based on a number of factors to obtain a certain type of photography or a certain representation of a scene. For example, during a zoom operation an image capture device may switch from a wide lens to a standard lens and to a telephoto lens as the zoom magnification is increased. When the device changes camera modules, the different camera modules have a different field of view that may cause an abrupt change in display of the image data. The abrupt change may be a shift in an object from one location to another location in a preview image displayed on the device. The device may use a transition time, such as a few frames or a few seconds, during which the output from the new camera module is transformed to closely resemble the output from the previous camera module. The transformation amount may decrease during the transition time such that the abrupt shift in objects on the preview image is instead a soft transition. In scenes with objects at multiple depths, such as a foreground portion and a background portion, the transformation to align image data from one camera module to resemble output from another camera module may cause artefacts such as when a straight object, such as a telephone pole, exists in the image because different portions of the pole may be differently transformed causing the pole to no longer appear straight.

Different portions of the image data may be differently transformed by applying different weights to the different segments within mask 206. For example, a background portion may be transformed at block 208 according to a first weight applied to an alignment difference between two camera modules. A foreground portion may be transformed at block 210 according to a second weight applied to the alignment difference between two camera modules. The differently-transformed portions of the image data may be combined at block 212 to determine an output image frame 214.

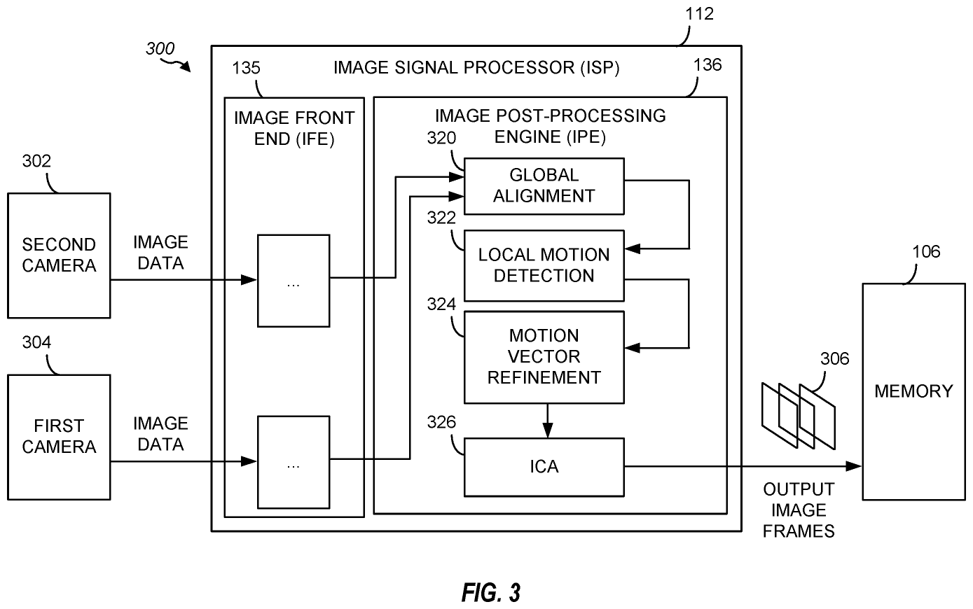

In some embodiments, the application of differently-weighted transforms through segmentation may be performed based on a motion vector map as shown in the system of FIG. 3. FIG. 3 shows a block diagram illustrating an example processor for processing image data for aligning image data when switching between cameras according to some embodiments of the disclosure. The processor 112 may receive image data from a first camera module 304 and a second camera module 302. The processor 112 may process the image data through, for example, IFE 135 and IPE 136 to determine output image frames 306. In one example, the image capture device may execute a preview mode of a camera application that displays a live feed from the camera modules 302 and/304. During operation, the processor may determine, or be commanded, to switch from first camera module 304 to second camera module 302. For a transition period after the camera module switch, the IPE 136 may apply transformations through image correction and adjustment (ICA) block 326 as part of determining the output image frames 306. The transformation in ICA 326 may be based on processing performed by global alignment block 320, local motion detection block 322, and/or motion vector refinement module 324.

The image data from a current camera module, such as the first camera module 304, is input to global alignment block 320 to determine a global alignment matrix. The image data and/or other data may be provided to local motion detection block 322 for determining a motion vector map based on the image data. The motion vector map, image data, and/or other data may be provided to motion vector refinement block 324 to determine a refined local motion vector map. The ICA 326 may apply a transformation to the image data based on the global alignment matrix and the refined local motion vector map. For example, the ICA 326 may apply the first weight to a foreground segment and a second weight to a background segment, with the foreground and background segments determined based on the ROI-enhanced, refined local motion vector map. The refinement to the local motion vector map reduces distortion caused by ICA 326. For example, a smoother zooming experience may be obtained when the refined results in additional warping to a foreground object. As another example, local motion compensation may be applied more accurately to only foreground objects to reduce distortion in background objects. In some embodiments, only motion vectors covered by the refined local motion vector map may be selected and used for warping in ICA 326.

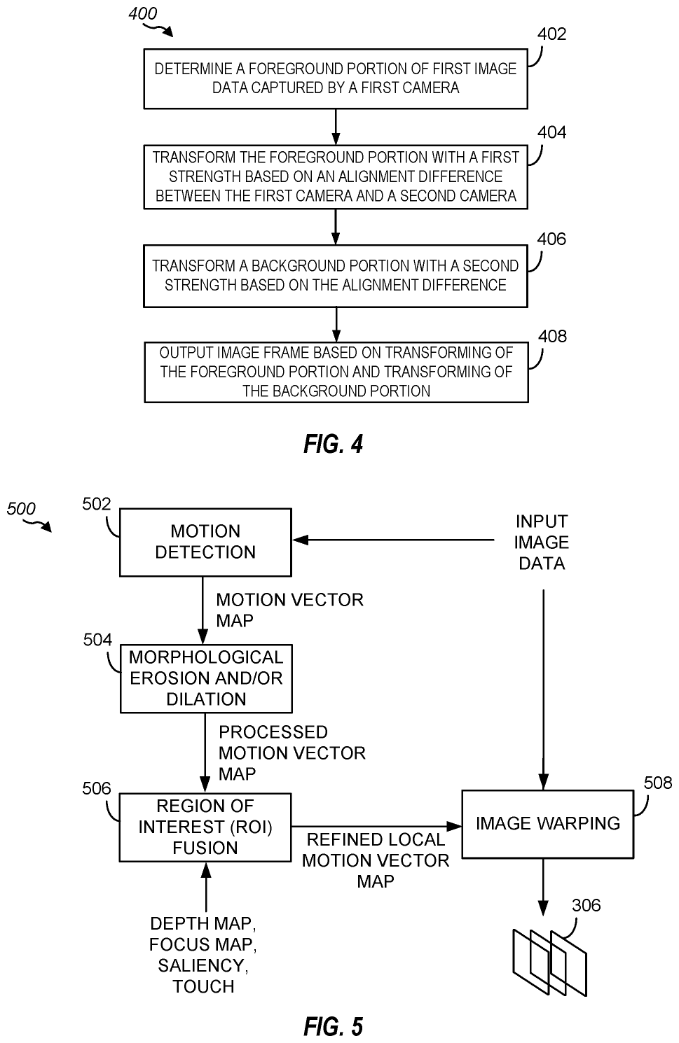

An example method for determining output image frames by applying different transformations to different portions of image data is shown in FIG. 4. FIG. 4 shows a flow chart illustrating an example method for processing image data according to some embodiments of the disclosure. A method 400 includes, at block 402, determining a first portion, such as a foreground portion, of first image data captured by a first camera. The method 400 may be performed by a processor after recently switching camera modules from a second camera module to a first camera module.

The determination of the first or foreground portion may include determining a motion vector map and refining the motion vector map through further processing. For example, local motion detection may be performed on the image data to determine a motion vector map. In some embodiments the local motion detection may execute on a globally-aligned image pair using optical flow. The motion vector map may be processed to apply morphological erosion and dilation to reduce noise and/or fill holes to reduce random distortion that may appear in an output image frame.

The morphological erosion and dilation operation may include execution of a foreground finding algorithm or be followed by a foreground finding algorithm. In some embodiments, the foreground finding algorithm may use connected components labeling to identify potential foreground regions. In some embodiments, the foreground finding algorithm may consider regions whose total area exceeds a threshold as target foreground. In some embodiments, the foreground finding algorithm may calculate average, minimum, and maximum shift values for each target foreground. If multiple regions have similarly large shifts and the respective locations are nearby (e.g., within a threshold number of pixels), the multiple regions may be combined into one region, with a final foreground portion determined as the portion with a largest average shift.

In some embodiments, a confidence may be assigned to the identification of portions of the image data. If an average shift of the foreground portion is significantly higher (e.g., above a threshold amount) than the other regions, the confidence of the identification of the foreground portion may be set to high, otherwise the confidence of the identification of the foreground portion may be set to low.

The determination of a portion, such as a foreground portion, of the image data may include use of other sources of depth-related information, such as a depth map (which may be received from, e.g., laser ranging, time of flight (TOF), DFS, or PD depth map), a focus map, a user input identifying a region of interest, object tracking information, or other sources. For example, the initial foreground finding algorithm may generate a segmentation mask, which is fused with the other ROI information based on weights. The weights may be based on the confidence of the respective portion of the segmentation mask. For example, when the foreground determination confidence is low, a higher weight may be assigned to the other ROI information when fusing the segmentation mask with a depth map or focus map. In some embodiments, only motion vectors in the motion vector map covered by a fused ROI map are selected and used for transformation in the ICA.

The fused segmentation mask based on the refined motion vector map may be used to determine the foreground portion of the image data, such that different portions of the image data may be transformed differently. At block 404, the foreground portion may be transformed with a first strength based on an alignment difference between the first camera and the second camera. At block 406, the background portion may be transformed with a second strength based on the alignment difference between the first camera and the second camera. The alignment difference may be represented as a global alignment matrix, which is applied to the image data according the first weight or the second weight. At block 408, an output image frame is determined based on the transforming of the foreground and background portions.

A block diagram representing a system for processing image data according to some embodiments of the disclosure using region of interest (ROI) identification information is shown in FIG. 5. FIG. 5 shows a block diagram illustrating an example method for processing image data with region of interest (ROI) identification according to some embodiments of the disclosure. A system 500 includes a motion detection block 502, which receives input image data and determines a motion vector map. A motion vector refinement block 504 may apply a morphological erosion and/or dilation to the motion vector map to determine a processed motion vector map. The processed motion vector map may be fused with region of interest (ROI) information (e.g., a depth map, a focus map, saliency, user touch input) to produce a refined local motion vector map. The refined local motion vector map may be provided to image warping block 508, such as ICA 326, to determine output image frames 306. The refined local motion vector map may be used as a weight map during image warping at block 508 or the refined local motion vector map may be used to determine a weight map. The output image frame 306 may then be produced from two input image data based on a first set of values specifying the first strength corresponding to the first portion of the first image data and a second set of values specifying the second strength corresponding to the second portion of the first image data.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to perform operations including receiving first image data from a first camera of an image capture device, wherein the first camera is different from a second camera of the image capture device; determining a first portion of the first image data; transforming the first portion of the first image data with a first strength based on an alignment difference between the first camera and the second camera; transforming a second portion of the first image data with a second strength based on the alignment difference between the first camera and the second camera; and determining a first output image frame based on the first image data after transforming the first portion of the first image data and transforming the second portion of the first image data. Additionally, the apparatus may perform or operate according to one or more aspects as described below. In some implementations, the apparatus includes a wireless device, such as a UE or BS. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the first portion comprises a foreground portion; and the second portion comprises a background portion.

In a third aspect, in combination with one or more of the first aspect or the second aspect, determining the foreground portion of the first image data comprises determining a motion vector map corresponding to the first image data, wherein the foreground portion is based on the motion vector map.

In a fourth aspect, in combination with one or more of the first aspect through the third aspect, determining the foreground portion of the first image data further comprises filling holes in the motion vector map to determine a processed motion vector map, wherein the foreground portion is based on the processed motion vector map.

In a fifth aspect, in combination with one or more of the first aspect through the fourth aspect, determining the foreground portion of the first image data is further based on region of interest (ROI) information.

In a sixth aspect, in combination with one or more of the first aspect through the fifth aspect, the region of interest (ROI) information comprises a depth map corresponding to the first image data.

In a seventh aspect, in combination with one or more of the first aspect through the sixth aspect, determining the foreground portion of the first image data comprises: determining a confidence level associated with determining the foreground portion based on the motion vector map; and determining a weight mask by fusing the motion vector map with the region of interest (ROI) information based on the confidence level, wherein the foreground portion is determined based on the weight mask.

In an eighth aspect, in combination with one or more of the first aspect through the seventh aspect, the operations further include determining a weight map.

In a ninth aspect, in combination with one or more of the first aspect through the eighth aspect, determining the weight map may include operations of determining a first set of values specifying the first strength corresponding to the first portion of the first image data; and determining a second set of values specifying the second strength corresponding to the second portion of the first image data, wherein determining the first output image frame is based on the weight map.

In a tenth aspect, in combination with one or more of the first aspect through the ninth aspect, transforming the foreground portion reduces an image shift between the first output image frame and a previous output image frame from the second camera.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-5 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
receiving first image data from a first camera of an image capture device, wherein the first camera is different from a second camera of the image capture device;
determining a first portion of the first image data;
transforming the first portion of the first image data with a first strength based on an alignment difference between the first camera and the second camera;
transforming a second portion of the first image data with a second strength based on the alignment difference between the first camera and the second camera; and
determining a first output image frame based on the first image data after transforming the first portion of the first image data and transforming the second portion of the first image data.

2. The method of claim 1, wherein:
the first portion comprises a foreground portion; and
the second portion comprises a background portion.

3. The method of claim 2, wherein determining the foreground portion of the first image data comprises determining a motion vector map corresponding to the first image data, wherein the foreground portion is based on the motion vector map.

4. The method of claim 3, wherein determining the foreground portion of the first image data further comprises filling holes in the motion vector map to determine a processed motion vector map, wherein the foreground portion is based on the processed motion vector map.

5. The method of claim 3, wherein determining the foreground portion of the first image data is further based on region of interest (ROI) information.

6. The method of claim 5, wherein the region of interest (ROI) information comprises a depth map corresponding to the first image data.

7. The method of claim 5, wherein determining the foreground portion of the first image data comprises:
determining a confidence level associated with determining the foreground portion based on the motion vector map; and
determining a weight mask by fusing the motion vector map with the region of interest (ROI) information based on the confidence level,
wherein the foreground portion is determined based on the weight mask.

8. The method of claim 1, further comprising determining a weight map comprising:
determining a first set of values specifying the first strength corresponding to the first portion of the first image data; and
determining a second set of values specifying the second strength corresponding to the second portion of the first image data,
wherein determining the first output image frame is based on the weight map.

9. The method of claim 1, wherein transforming the first portion reduces an image shift between the first output image frame and a previous output image frame from the second camera.

10. The method of claim 1, further comprising:
receiving second image data from the first camera of the image capture device;
determining a foreground portion of the second image data;
determining a second foreground portion of the second image data;
transforming the second foreground portion of the second image data with a third strength based on the alignment difference between the first camera and the second camera; and
transforming a second background portion of the second image data with a fourth strength based on the alignment difference between the first camera and the second camera,
wherein:
the third strength is less than the first strength; and
the fourth strength is less than the second strength.

11. An apparatus, comprising:
a memory storing processor-readable code; and
at least one processor coupled to the memory, the at least one processor configured to execute the processor-readable code to cause the at least one processor to perform operations including:
receiving first image data from a first camera of an image capture device, wherein the first camera is different from a second camera of the image capture device;
determining a first portion of the first image data;
transforming the first portion of the first image data with a first strength based on an alignment difference between the first camera and the second camera;
transforming a second portion of the first image data with a second strength based on the alignment difference between the first camera and the second camera; and
determining a first output image frame based on the first image data after transforming the first portion of the first image data and transforming the second portion of the first image data.

12. The apparatus of claim 11, wherein:
the first portion comprises a foreground portion; and
the second portion comprises a background portion.

13. The apparatus of claim 12, wherein determining the foreground portion of the first image data comprises determining a motion vector map corresponding to the first image data, wherein the foreground portion is based on the motion vector map.

14. The apparatus of claim 13, wherein determining the foreground portion of the first image data further comprises filling holes in the motion vector map to determine a processed motion vector map, wherein the foreground portion is based on the processed motion vector map.

15. The apparatus of claim 13, wherein determining the foreground portion of the first image data is further based on region of interest (ROI) information.

16. The apparatus of claim 15, wherein the region of interest (ROI) information comprises a depth map corresponding to the first image data.

17. The apparatus of claim 15, wherein determining the foreground portion of the first image data comprises:
determining a confidence level associated with determining the foreground portion based on the motion vector map; and
determining a weight mask by fusing the motion vector map with the region of interest (ROI) information based on the confidence level,
wherein the foreground portion is determined based on the weight mask.

18. The apparatus of claim 11, wherein the at least one processor is further configured to execute the processor-readable code to cause the at least one processor to perform operations including:
determining a weight map comprising:
determining a first set of values specifying the first strength corresponding to the first portion of the first image data; and
determining a second set of values specifying the second strength corresponding to the second portion of the first image data,
wherein determining the first output image frame is based on the weight map.

19. The apparatus of claim 11, wherein transforming the first portion reduces an image shift between the first output image frame and a previous output image frame from the second camera.

20. The apparatus of claim 19, wherein the at least one processor comprises an image signal processor (ISP).

21. A non-transitory computer-readable medium storing instructions that, when executed by a processor, cause the processor to perform operations comprising:
receiving first image data from a first camera of an image capture device, wherein the first camera is different from a second camera of the image capture device;
determining a first portion of the first image data;
transforming the first portion of the first image data with a first strength based on an alignment difference between the first camera and the second camera;
transforming a second portion of the first image data with a second strength based on the alignment difference between the first camera and the second camera; and
determining a first output image frame based on the first image data after transforming the first portion of the first image data and transforming the second portion of the first image data.

22. The non-transitory computer-readable medium of claim 21, wherein:
the first portion comprises a foreground portion; and
the second portion comprises a background portion.

23. The non-transitory computer-readable medium of claim 22, wherein determining the foreground portion of the first image data comprises determining a motion vector map corresponding to the first image data, wherein the foreground portion is based on the motion vector map.

24. The non-transitory computer-readable medium of claim 23, wherein determining the foreground portion of the first image data further comprises filling holes in the motion vector map to determine a processed motion vector map, wherein the foreground portion is based on the processed motion vector map.

25. The non-transitory computer-readable medium of claim 23, wherein determining the foreground portion of the first image data is further based on region of interest (ROI) information.

26. The non-transitory computer-readable medium of claim 25, wherein the region of interest (ROI) information comprises a depth map corresponding to the first image data.

27. The non-transitory computer-readable medium of claim 25, wherein determining the foreground portion of the first image data comprises:
determining a confidence level associated with determining the foreground portion based on the motion vector map; and
determining a weight mask by fusing the motion vector map with the region of interest (ROI) information based on the confidence level,
wherein the foreground portion is determined based on the weight mask.

28. The non-transitory computer-readable medium of claim 21, wherein the instructions, when executed by a processor, cause the processor to perform further operations comprising:
determining a weight map comprising:
determining a first set of values specifying the first strength corresponding to the first portion of the first image data; and
determining a second set of values specifying the second strength corresponding to the second portion of the first image data,
wherein determining the first output image frame is based on the weight map.

29. The non-transitory computer-readable medium of claim 21, wherein transforming the first portion reduces an image shift between the first output image frame and a previous output image frame from the second camera.

30. The non-transitory computer-readable medium of claim 21, wherein the instructions, when executed by a processor, cause the processor to perform further operations comprising:
receiving second image data from the first camera of the image capture device;
determining a foreground portion of the second image data;
determining a second foreground portion of the second image data;
transforming the second foreground portion of the second image data with a third strength based on the alignment difference between the first camera and the second camera; and
transforming a second background portion of the second image data with a fourth strength based on the alignment difference between the first camera and the second camera,
wherein:
the third strength is less than the first strength; and
the fourth strength is less than the second strength.
